(19) United States
(12) Patent Application Publication
(10) Pub. No.: US 2012/0281401 A1
(43) Pub. Date: Nov. 8, 2012

(54) OPTO-MECHANICAL SYSTEM WITH FUNCTION OF FOCUSING LIGHT BEAM

(75) Inventor: HSIAO-WU LI, Tu-Cheng (TW)

(73) Assignee: HON HAI PRECISION INDUSTRY CO., LTD., Tu-Cheng (TW)

(21) Appl. No.: 13/193,617

(22) Filed: Jul. 29, 2011

(30) Foreign Application Priority Data
May 5, 2011 (TW) 100115779

(51) Int. Cl. F21V 5/04

(52) U.S. Cl. 362/235

(57) ABSTRACT

An opto-mechanical system with a function of focusing light beams is provided. The opto-mechanical system includes a circuit board, a plurality of light-emitting elements mounted on the circuit board, and a light diffusing element placed in front of the light-emitting elements. The light-emitting elements emit point sources. The light diffusing element includes a diffusing surface and a focusing body fixed below the diffusing surface. The diffusing surface diffuses the point sources into a plurality of line sources. The focusing body focuses the plurality of line sources.

### BACKGROUND

1. Technical Field

The present disclosure relates to opto-mechanical systems, and particularly, to an opto-mechanical system with a function of focusing light beam.

2. Description of Related Art

Opto-mechanical systems usually include a circuit board, a number of light-emitting elements mounted on the circuit board, and a light diffusing element placed in front of the light-emitting elements. Each light emitting element emits a point source to the light diffusing element. The light diffusing element diffuses the point source into a number of line sources which is used to scan. However, because the point source is diffused by the light diffusing element, the brightness of the line source is reduced, which result in a shadowy effect when scanning.

Therefore, what is needed is an opto-mechanical system with a function of focusing light beam to overcome the described limitations.

### BRIEF DESCRIPTION OF THE DRAWINGS

FIG. 1 is a schematic diagram of an opto-mechanical system, in accordance with a first embodiment.

FIG. 2 shows a number of point sources being diffused by a light diffusing element of the opto-mechanical system of FIG. 1.

FIG. 3 is a schematic diagram of an opto-mechanical system, in accordance with a second embodiment.

### DETAILED DESCRIPTION

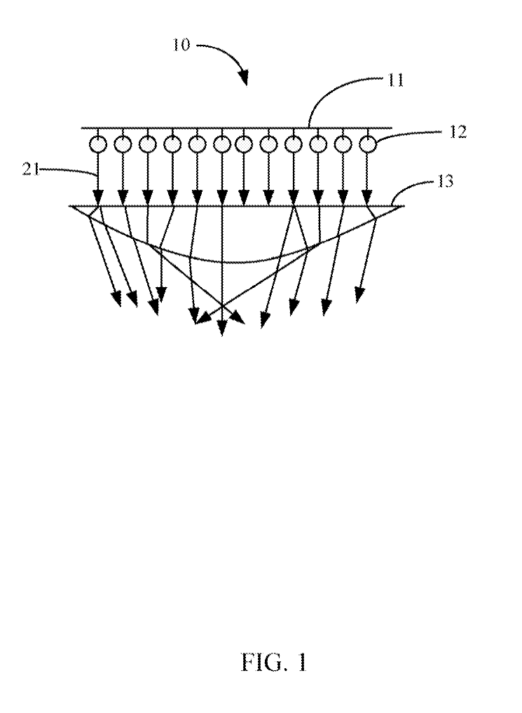

Referring to FIG. 1, an opto-mechanical system 10 with a function of focusing light beam is provided. The opto-mechanical system 10 includes a circuit board 11, a number of light-emitting elements 12 mounted on the circuit board 11, and a light diffusing element 13. The light-emitting elements 12 are configured to emit point sources. In one embodiment, the light-emitting elements 11 may be LEDs, or lasers.

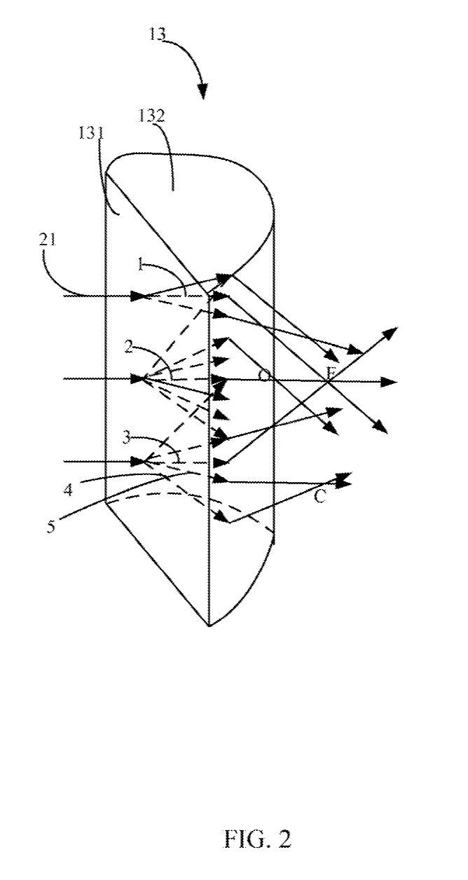

Referring to FIG. 2, the light-diffusing element 13 includes a diffusing surface 131 placed in front of the light-emitting elements 12 and a focusing body 132 fixed to the diffusing surface 131. The diffusing surface 131 is configured to diffuse the number of point sources 21 into a number of line sources. The focusing body 132 is configured to focus the number of line sources from the diffusing surface 131, thereby enhancing brightness of the line sources. In one embodiment, the focusing body 132 is an arc-shaped lens. In other embodiment, the focusing body 132 may be other lenses having a function of focusing light beam.

Referring to FIG. 2 again, there are three light-emitting elements 12 emitting three point sources 21 to the diffusing surface 131. The diffusing surface 131 diffuses the three point sources 21 into a number of line sources. The focusing body 132 focuses the number of line sources from the diffusing surface 131. For example, the focusing body 132 focuses the line sources 1, 2, and 3 into focus F, and focuses the line sources 4 and 5 into point C, etc. During the process of diffusing the point sources, the brightness of the line sources is reduced. If the line sources with lower brightness are used to scan, this will result in a shadowy effect. Therefore, to the focusing body 132 can focus the number of line sources to enhance the brightness of the line sources to overcome the above problem.

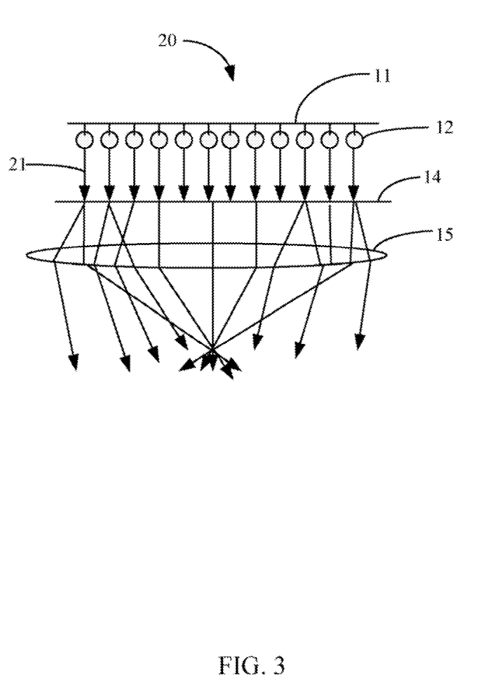

Referring to FIG. 3, an opto-mechanical system 20 is provided in the second embodiment. The opto-mechanical system 20 includes a circuit board 11, a number of light-emitting elements 12 mounted on the circuit board 11, a diffusing surface 14 placed in front of the light-emitting element 12, and a lens 15 placed in front of the diffusing surface 14. The diffusing surface 14 diffuses the point sources 21 into a number of line sources. The lens 15 focuses the number of line sources from the diffusing surface 14.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An opto-mechanical system with a function of focusing light beams, comprising:
a circuit board;
a plurality of light-emitting elements mounted on the circuit board, and configured to emit point sources; and
a light diffusing element placed in front of the light-emitting elements, and comprising:
a diffusing surface configured to diffuse the point sources into a plurality of line sources; and
a focusing body to focus the plurality of line sources.

2. The opto-mechanical system as described in claim 1, wherein the light-emitting elements are LEDs.

3. The opto-mechanical system as described in claim 1, wherein the light-emitting elements are lasers.

4. The opto-mechanical system as described in claim 1, wherein the focusing body is an are-shaped lens.

5. An opto-mechanical system with a function of focusing light beams, comprising:
a circuit board;
a plurality of light-emitting elements mounted on the circuit board, and configured to emit point sources;
a diffusing surface placed in front of the light-emitting elements, and configured to diffuse the point sources into a plurality of line sources; and
a focusing body placed in front of the diffusing surface, and to focus the plurality of line sources.
